(19) United States
(12) Patent Application Publication
(10) Pub. No.: US 2021/0061711 A1
(43) Pub. Date: Mar. 4, 2021

(54) Performance-Enhancing Cement Admixture Composition

(71) Applicant: NW Straw Pulp, LLC., Dayton, WA (US)

(72) Inventor: Keith C. Kuykendall, Waitsburg, WA (US)

(73) Assignee: NW Straw Pulp, LLC., Dayton, WA (US)

(21) Appl. No.: 17/004,784

(22) Filed: Aug. 27, 2020

Related U.S. Application Data
(60) Provisional application No. 62/893,284, filed on Aug. 29, 2019.

(51) Int. Cl. C04B 26/28; C04B 24/38; C04B 18/24

(52) U.S. Cl. CPC C04B 26/285; C04B 2111/00017; C04B 18/24; C04B 24/383

(57) ABSTRACT

A performance-enhancing cement admixture composition is disclosed. The composition comprises water and a concentrated biopolymer composition derived from wheat straw, alfalfa, or other cereal grain straws. The concentrated biopolymer composition may include inorganic material and a copolymer comprised of lignin and polysaccharides.

### FIELD OF DISCLOSURE

This disclosure generally relates to cement admixture compositions and, more particularly, to compositions containing a biopolymer composition.

### BACKGROUND

Cement-based products have broad functional requirements within various commercial and industrial applications. Admixtures are commonly incorporated into the cement mixture during the mixing phase to alter characteristics including set rate, flow traits, water-to-cement ratio, compressive strength, resistance to permeability, and resistance to freeze/thaw impacts. These admixtures are readily available in both liquid and powder form and are typically derived from petroleum products. In some cases, cement admixtures formulated from agricultural derivatives and various pulping by-products are used. While varying in their effectiveness, such products may present drawbacks such as inconsistencies in set time, viscosity, workability, compressive strength, air entrainment, permeability, and levels of cracking and/or shrinkage. Furthermore, many of these products have significant negative environmental impacts during their manufacturing process or represent ecotoxicity risks associated with their shipping and handling. Consequently, there is a need for admixtures that reduce such drawbacks or otherwise enhance the performance of cement products with minimal environmental impact.

The present disclosure is designed to solve the problems described above.

### SUMMARY

In accordance with one aspect of the present disclosure, a performance-enhancing cement admixture composition is disclosed. The composition may comprise water and a concentrated biopolymer composition. The concentrated biopolymer composition may be derived from wheat straw, alfalfa, or other cereal grain straws, and may include inorganic material and a copolymer comprised of lignin and polysaccharides.

The concentrated biopolymer composition is obtained as a lignin/hemicellulose co-product from pulp processing of wheat straw, alfalfa, or other cereal grain straws. The concentrated biopolymer composition may contain 25-55% total solids and may include inorganic material and a copolymer comprised of lignin and polysaccharides.

In accordance with another aspect of the present disclosure, a method of making a performance-enhancing cement admixture composition is disclosed. The method may comprise obtaining a dilute liquor derived from wheat straw, alfalfa, or other cereal grain straws. The dilute liquor may include water, inorganic material, and a copolymer comprised of lignin and polysaccharides. The dilute liquor may include 5-12% by weight of total solids. The method may further comprise filtering the dilute liquor to remove undissolved fiber related solids; concentrating the dilute liquor to provide a concentrated biopolymer composition comprising 25-55% by weight total solids; and producing a performance-enhancing cement admixture composition, which may be in a wet-form or a dry-form.

These and other aspects and features of the present disclosure will be more readily understood when read in conjunction with the accompanying drawings.

### BRIEF DESCRIPTION OF THE DRAWINGS

FIG. 1 is a flowchart illustrating a series of steps involved in making the performance-enhancing cement admixture composition of the present disclosure.

### DETAILED DESCRIPTION OF THE DISCLOSURE

While the invention described herein may be embodied in many forms, there will herein be described in detail one or more embodiments with the understanding that this disclosure is to be considered an exemplification of the principles of the invention and is not intended to limit the disclosure to the specific embodiments. Aspects of the different embodiments can be combined with or substituted for one another.

The present disclosure pertains to a performance-enhancing cement admixture composition and a method of making a performance-enhancing cement admixture composition. The performance-enhancing cement admixture composition may be incorporated into concrete mixes prior to concrete placement as a water reducing agent, a set retarder, an air entrainer, a corrosion inhibitor, or to increase the compressive strength throughout the curing process and after curing has completed. Additionally, the composition may reduce corrosive impacts to rebar and other ferrous metals in contact with the concrete, reduce cracking and shrinking, improve workability, resist freeze/thaw damage, reduce permeability, and reduce surface bleeding. This composition acts as a novel performance-enhancing admixture to cementitious products.

The performance-enhancing cement admixture composition comprises a concentrated biopolymer composition derived from wheat straw, alfalfa, or other cereal grain straws. A dilute lignin liquor is obtained from a lignin/hemicellulose co-product produced from cellulose material during pulp processing of non-wood sources including wheat straw, alfalfa, or other cereal grain straws such as, but not limited, to rice straw, barley straw, oat straw, and flax straw. The dilute liquor may have a total solids content of between 5 and 12 percent on a weight basis, with the remainder being water. This dilute liquor is further processed into the concentrated biopolymer composition. In one embodiment, the concentrated biopolymer composition comprises about 25-50% by weight water, about 5-20% by weight lignin, about 5-20% by weight polysaccharides, and about 15-30% by weight inorganic elements. In a specific embodiment, the concentrated biopolymer composition comprises about 50% by weight water, about 12.5% by weight lignin, about 12.5% by weight polysaccharides, and about 25% by weight of inorganic materials. The chemical and physical properties of the concentrated biopolymer composition are discussed in more detail in the following section.

The concentrated biopolymer composition is further processed into a performance-enhancing cement admixture composition. The cement admixture may be produced in a wet-form or a dry-form. In a wet-form, the cement admixture composition includes 45-75% water and 25-55% of the concentrated biopolymer composition. The wet-form cement admixture composition may be used at a dose of 0.5-10 ounces per 100 lbs. of cement.

The dry-form cement admixture composition is produced by drying the concentrated biopolymer composition until it comprises about 0-5% by weight water, about 10-20% by weight lignin, about 10-20% by weight polysaccharides, and about 30-60% by weight inorganic elements. The wet-form cement admixture composition may be used at a dose of 0.25-1.0 lbs. per 100 lbs. of cement.

The biopolymer derived cement admixture composition is not derived from and does not compete with food or food sources and outperforms other organic admixtures as a performance-enhancer for cement. The use of the biopolymer composition as a cement admixture provides an industrial application for excess wheat straw residue remaining in fields after wheat straw harvesting.

Furthermore, the biopolymer composition acts as a corrosion inhibitor as the copolymer ion exchange sites attach to metal surfaces, forming a surface layer that protects against corrosion by salts of magnesium, calcium, and sodium. As such, the cement admixture composition of the present disclosure reduces the harmful corrosive impacts of salts that come in contact with rebar and other structural steel components.

Moreover, the biopolymer composition of the present disclosure entrains small air bubbles within the concrete mixture thereby reducing negative impacts of freeze/thaw cycles.

Additionally, the biopolymer composition retards the time for concrete to set in accordance with the amount of biopolymer added to the mix. In one embodiment, the use of 4-6 oz of cement admixture composition in the wet-form per one-hundred pounds of Portland cement used may result in an increased set time of 0.5 - 3.5 hours as compared to a Vinsol resin control agent.

A nationally recognized independent concrete testing laboratory conducted a standard water reducing agent (WRA) Type A test per ASTM C494, AASHTO M194 test methods on one embodiment of this performance-enhancing cement admixture (see Table 1 below).

TABLE 1
Type A WRA Test Results

| | | | Comp. | Comp. | Comp. |
|---|---|---|---|---|---|
| | Water | Set Time | Strength | Strength | Strength |
| Dose Rate | Reduction | Delay | (3 day) | (7 day) | (21 day) |
| 5.8 oz/cwt | 5% | 2:08-3:12 hr. | 4285 psi | 5085 psi | 5975 psi |

Water reduction targets beyond 5% may be achieved with higher amounts of the admixture. This embodiment acts as a WRA and set retarder. The compressive strength gains are in excess of that which would be attributed to water reduction alone.

Further testing by the independent lab was conducted to quantify air entrainment in accordance with ASTM C457, procedure A. This embodiment of the performance-enhancing cement admixture was found to contain an air void system which is consistent with the current American Concrete Institute (ACI) recommendations for freeze-thaw resistance.

While mixing and handling the concrete containing 5.8 oz/cwt of cement it was noted to have more workability than typical wood pulp lignin WRA's, and that the slump loss over time was limited.

### Chemical and Physical Properties of the Biopolymer Composition

In one embodiment, the concentrated biopolymer composition includes 25-55% weight percent total solids. In a specific embodiment, the concentrated biopolymer composition includes about 50% weight percent total solids.

In one embodiment, the concentrated biopolymer composition comprises about 25-50% by weight water, about 5-20% by weight lignin, about 5-20% by weight polysaccharides, and about 15-30% by weight inorganic elements. In a specific embodiment, the concentrated biopolymer composition comprises about 50% by weight water, about 12.5% by weight lignin, about 12.5% by weight polysaccharides, and about 25% by weight of inorganic materials.

The specific gravity of the concentrated biopolymer composition varies from about 1.25 to 1.35 g/ml depending on the concentration of solids. Thus, the copolymer of the present disclosure is less soluble at a pH range below 7.5 than other alkali lignins. The performance-enhancing cement admixture compositions of the present disclosure may have a pH of 8-11, and a specific gravity of 1.25-1.35.

The polysaccharides in the biopolymer composition are bonded to the lignin as a copolymer. The polysaccharides may at least include polydisperse hemicellulose of varying molecular sizes. The lignin may be polydisperse and of varying molecular sizes (see Table 2 below). The polydisperse lignin and the polydisperse hemicellulose can be present as a copolymer, or each of the polydisperse lignin and the polydisperse hemicellulose can be present separately.

TABLE 2
Molar Mass Distribution of Biopolymer Lignin
Fraction (Gel Permeation Chromatography data)

| Number-average | Peak molecular | Weight-average | Z-average | |
|---|---|---|---|---|
| molecular weight | weight (Mp) | molecular weight | molecular weight | |
| (Mn) (Daltons) | (Daltons) | (Mw) (Daltons) | (Mz) (Da) | Mw/Mn |
| 3878-5120 | 4304-6638 | 11288-22287 | 25570-148361 | 3.4-5.6 |

The lignin may have a high content of hydroxyl (OH) and carboxylic acid (COOH) groups as compared to lignin derived from wood-species pulping processes (see Table 3 below). The methoxy (OMe) group content is provided in Table 4 below.

TABLE 3
Hydroxyl (OH) and Carboxyl (COOH) Group
Content of Biopolymer Lignin Fraction.

| Group | mmol/g |
|---|---|
| aliphatic OH | 1.38-2.88 |
| syringyl, condensed | 0.22-0.57 |
| guaiacyl, catechol | 0.27-0.67 |
| aromatic OH | 0.48-1.24 |
| carboxyl COOH | 0.31-0.92 |
| Total OH | 1.87-4.12 |

TABLE 4
Methoxy (OMe) Group Content of Biopolymer Lignin Fraction.

| Average OMe, mmol/g | STDEV, mmol/g | RSD, % |
|---|---|---|
| 2.72-4.72 | 0.03-0.10 | 0.54-3.60 |

The biopolymer composition may include solids, wherein the total solids in the biopolymer composition includes dissolved solids and, in some cases, a small fraction of undissolved solids. The undissolved solids may include suspended or colloidal solids.

The polysaccharides in the biopolymer composition includes a mixture of five and six carbon sugars. According to sugar analysis performed by acid methanolysis, the predominant five carbon sugars include xylose (Xyl) and arabinose (Ara), and the predominant six carbon sugars include glucose (Glc), galactose (Gal), galacturonic acid (GalUA), glucuronic acid (GlcUA), and 4-O-methylglucouronic acid (4OMeGlcUA). In addition to these sugars, the polysaccharides further include sugar units of rhamnose (Rha), fucose (Fuc), and mannose (Man). The biopolymer composition contains little to no fructose and, therefore, little to no sucrose (a disaccharide of glucose and fructose). In one embodiment, the polysaccharides may have about 60% five carbon sugars and about 40% six carbon sugars. The biopolymer composition has a low concentration of low molecular weight saccharinic acids derived from the sugars when treated under alkaline conditions. Isosaccharinic acids are formed from the six carbon sugars, and a comparable acid is formed from xylose. These acids form strong and stable complexes with di- and trivalent cations.

The biopolymer composition contains a high content of alkyl and aromatic groups. The lignin reacts easily at the β-O-4 position forming alkyl and aromatic hydroxyl groups. In addition, the lignin of the biopolymer composition of the present disclosure has a higher content of carboxylic acid groups and a higher oxygen/carbon (O/C) ratio than lignins derived from other types of pulping processes. The high content of hydroxyl and carboxylic acid (COOH) (see Table 1) provide the biopolymer composition with a high cation exchange capacity, with all cations exchanging with the lignin. The polysaccharides in the biopolymer composition also contain hydroxyl and carboxylic acid groups. Reaction of the lignin β-O-4 cross-linked groups leads to low lignin molecular weights (from about 2,000 to about 20,000). The low lignin molecular weight combined with a high hydroxyl group content leads to a higher lignin reactivity.

The polysaccharides in the biopolymer composition are chemically bonded to lignin and tend to keep the copolymer dissolved at a pH equal to 7.5 and above. By contrast, other alkaline lignins are soluble in water across the pH range of 1-14. Thus, the copolymer of the present disclosure is less soluble at a pH range below 7.5 than other alkali lignins.

The amorphous nature of the lignin/hemicellulose copolymers results in medium and large molecules (heavy molecular weight), providing the copolymer with polydispersity (see Table 4).

No statistically significant chronic toxicity was found in the Fathead Minnow (Pimephales promelas) survival test at any of the concentrations tested. No statistically significant chronic toxicity was found in the Ceridaphnia dubia survival test at any of the concentrations tested. Further, no statistically significant toxicity was found in the freshwater green algae (Selenastrum capricornutum) growth inhibition study at any of the concentrations tested.

### Method of Making the Performance-Enhancing Cement Admixture

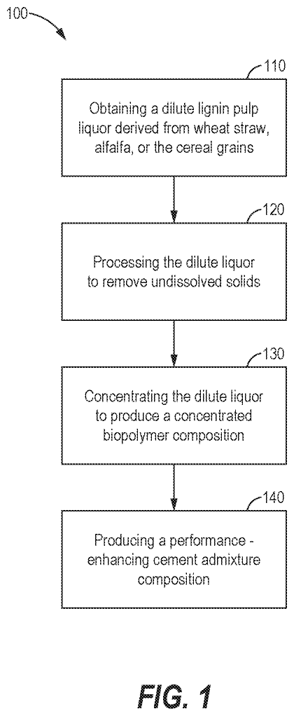

Initially, a dilute biopolymer composition (or “liquor”) is obtained as a dilute lignin/hemicellulose co-product from pulp processing of wheat straw, alfalfa, or other cereal grain straws (see FIG. 1, block 110). This dilute liquor is an aqueous solution including inorganic material and a polydisperse copolymer of lignin and polysaccharides and contains approximately 5-12% total solids including both dissolved and undissolved solids. Subsequently, the liquor is further processed and filtered to remove the undissolved solids through a combination of solid removal steps including multiple settling and decanting steps, and filtration through mechanical systems, such as through a 100-micron bag-type filter, a frame and plate disk filter, dissolved air filter, and/or a decanter centrifuge (block 120). The filtration steps to remove undissolved solids may be optionally assisted with one or more surfactants, dispersants, flocculants, and/or coagulants. For instance, the filtration step may be assisted with one or more surfactants to aid in the separation of fibrous fines.

The filtered liquor is then concentrated to reduce the water content to about 25-50% by weight, producing a concentrated biopolymer composition (block 130). For this purpose, suitable drying/evaporation technologies include, but are not limited to, multi-effect evaporation, spray drying, freeze drying, and/or drum drying. Optionally, a defoaming agent may be used to reduce foaming of the biopolymer during concentration and subsequent blending with the chloride salts.

The concentrated biopolymer may include 5-20% by weight lignin, 5-20% by weight polysaccharides, and 15-30% by weight inorganic material. After concentration, the content of total solids in the concentrated biopolymer composition is 25-55% by weight. The total solids remaining after the filtration step includes mostly dissolved solids and a small fraction of undissolved solids (including colloidal solids). Optionally, one or more cationic, anionic, and/or nonionic surfactants, coagulants, and dispersants may be added to the biopolymer composition to affect the suspension of precipitates of lignin/hemicellulose under varied concentrations and pH ranges.

The method may further include producing a performance-enhancing cement admixture composition (block 140). This admixture composition may be in either a wet-form or a dry-form.

To produce the wet-form of the cement admixture composition, the concentrated biopolymer composition is mixed with water. In some embodiments, the wet-form cement admixture compositions may comprise 45-75% water and 25-55% of the concentrated biopolymer composition. The wet-form cement admixture composition may be used at a dose of 0.5-10 ounces per 100 lbs. of cement. In addition, the method may further comprise blending the concentrated biopolymer composition with a dispersant.

The dry-form cement admixture composition is produced by drying the concentrated biopolymer composition until it comprises about 0-5% by weight water, about 10-20% by weight lignin, about 10-20% by weight polysaccharides, and about 30-60% by weight inorganic elements. The wet-form cement admixture composition may be used at a dose of 0.25-1.0 lbs. per 100 lbs. of cement.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims.

What is claimed is:

1. A performance-enhancing cement admixture composition, comprising:
water; and
a concentrated biopolymer composition,
wherein the concentrated biopolymer composition is derived from at least one of wheat straw, alfalfa, or other cereal grain straws, and comprises at least one inorganic material and a copolymer comprised of lignin and a plurality of polysaccharides.

2. The composition of claim 1, wherein the cement admixture composition comprises:
45-75% by weight water; and
25-55% by weight of the concentrated biopolymer composition.

3. The composition of claim 1, wherein the cement admixture composition is configured to be added to a cement at a dose rate of 0.5-10 oz per 100 lb. of cement.

4. The composition of claim 1, wherein the concentrated biopolymer composition comprises about 25-50% by weight water, about 5-20% by weight of the lignin, about 5-20% by weight of the plurality of polysaccharides, and about 15-30% by weight of the inorganic material.

5. The composition of claim 1, wherein the plurality of polysaccharides include polymeric hemicellulose.

6. The composition of claim 1, wherein the plurality of polysaccharides include sugar units of xylose, arabinose, glucose, galactose, galacturonic acid, gluconuronic acid, rhamnose, fucose, 4-methyl glucouronic acid, mannose, or related saccharinic acids derived from the sugars when treated under alkaline conditions.

7. The composition of claim 1, wherein the plurality of polysaccharides include polydisperse hemicellulose.

8. The composition of claim 1, wherein the lignin is polydisperse.

9. A performance-enhancing cement admixture composition comprising a concentrated biopolymer composition derived from at least one of wheat straw, alfalfa, or other cereal grain straws, wherein the concentrated biopolymer composition includes 0-5% by weight water, 10-20% by weight of lignins, 10-20% by weight of a plurality of polysaccharides, and 30-60% by weight of inorganic materials.

10. The composition of claim 1, wherein the cement admixture composition is configured to be added to a cement at a dose rate of 0.25-1.0 lb. per 100 lb. of cement.

11. A method of making a performance-enhancing cement admixture composition, comprising:
obtaining a dilute lignin pulp liquor derived from wheat straw, alfalfa, or other cereal grain straws, the dilute liquor including water, inorganic material, and a copolymer comprised of lignin and polysaccharides, the dilute liquor including 5-12% by weight of total solids;
filtering the dilute liquor to remove undissolved fiber related solids;
concentrating the dilute liquor to provide a concentrated biopolymer composition comprising about 25-55% by weight of total solids; and
producing a cement admixture composition, wherein the cement admixture composition may be a wet-form cement admixture composition or a dry-form cement admixture composition

12. The method of claim 11, wherein the concentrated biopolymer composition comprises about 25-50% by weight water, about 5-20% by weight of the lignin, about 5-20% by weight of the plurality of polysaccharides, and about 15-30% by weight of the inorganic material.

13. The method of claim 11, further comprising adding the wet-form cement admixture to a cement at a dose rate of 0.5-10 oz per 100 lb. of cement.

14. The method of claim 11, further comprising adding the dry-form cement admixture to a cement at a dose rate of 0.25-1.0 lb. per 100 lb. of cement.

15. The method of claim 11, wherein the wet-form cement admixture composition is produced by combining the concentrated biopolymer composition with water such that the wet-form cement admixture composition comprises:
45-75% by weight water; and
25-55% by weight of the biopolymer composition.

16. The method of claim 15, further comprising blending the wet-form cement admixture composition with a dispersant.

17. The method of claim 11, wherein the dry-form cement admixture composition is produced by drying the concentrated biopolymer composition such that the dry-form cement admixture composition comprises:
0-5% by weight water,
10-20% by weight of lignins,
10-20% by weight of a plurality of polysaccharides, and
30-60% by weight of inorganic materials.

18. The method of claim 11, wherein the plurality of polysaccharides include polymeric hemicellulose.

19. The method of claim 11, wherein the plurality of polysaccharides include polydisperse hemicellulose.

20. The method of claim 11, wherein the lignin is polydisperse.
